(19) United States
(12) Patent Application Publication
(10) Pub. No.: US 2012/0004110 A1
(43) Pub. Date: Jan. 5, 2012

(54) MAGNESIUM DIBORIDE SUPERCONDUCTING WIRE AND METHOD FOR MANUFACTURING SAME

(76) Inventors: Masaya TAKAHASHI, Hitachinaka (JP); Tsuyoshi Wakuda, Hitachinaka (JP); Yota Ichiki, Hitachinaka (JP); Kazuhide Tanaka, Hitachi (JP)

(21) Appl. No.: 13/172,062

(22) Filed: Jun. 29, 2011

(30) Foreign Application Priority Data
Jun. 30, 2010 (JP) 2010-149138

(51) Int. Cl. H01B 12/06; H01F 6/00; H01F 6/06; H01B 13/00

(52) U.S. Cl. 505/211; 505/433; 505/230; 174/125.1; 335/216

(57) ABSTRACT

It is an objective of the present invention to provide a method for manufacturing long lengths of MgB₂ superconducting wire having excellent superconducting properties and an MgB₂ superconducting wire manufactured thereby. There is provided a method for manufacturing a magnesium diboride superconducting wire, comprising the successive steps of: filling a metallic tube with a raw material powder; and subjecting the tube to wiredrawing processing, in which a fatty acid metal salt or a mixture of the fatty acid metal salt and a fatty acid is added to the raw material powder.

### CLAIM OF PRIORITY

The present application claims priority from Japanese patent application serial no. 2010-149138 filed on Jun. 30, 2010, the content of which is hereby incorporated by reference into this application.

### BACKGROUND OF THE INVENTION

1. Field of the Invention

The present invention relates to magnesium diboride (hereinafter referred to as MgB₂) superconducting wire and, in particular, to a method for manufacturing long lengths of homogeneous MgB₂ superconducting wire in a stable manner and an MgB₂ superconducting wire manufactured thereby.

2. Description of Related Art

An MgB₂ superconductor has the highest critical temperature (39 K) as a metallic superconductor and is expected to become a superconducting material to achieve a superconducting magnet that operates under liquid helium-free conditions (e.g. at temperatures ranging from 10 to 20 K). A superconducting wire comprising a superconducting magnet is required to maintain a high current density even in a strong magnetic field generated by itself and to be a long length (e.g., 1 km or longer) of homogeneous wire.

An MgB₂ superconducting wire is generally manufactured by filling a metallic sheath tube with a powder mix of magnesium (Mg) powder and boron (B) powder, an MgB₂ powder, or a powder mix of any of the foregoing and a ternary element, and by subjecting the tube to wiredrawing processing (what is called “powder-in-tube method”). Also, various research and development efforts have been made for the purpose of improving the superconducting properties of MgB₂ wire.

For example, JP-A 2004-192934 discloses an MgB₂ superconducting wire, wherein: a metallic powder is added to a superconducting material contained in the superconducting wire; the metallic powder is selected from at least one of indium, tin, lead, iron, magnesium, and aluminum; the metallic powder having an average grain diameter of less than or equal to 20 μm is dispersed in the superconducting material in an amount of 5 to 25 vol %; and the density of the superconducting material contained in the superconducting wire after the final process is greater than or equal to 90% of the theoretical density. According to JP-A 2004-192934, an MgB₂ superconducting wire that meets these requirements has better superconducting properties (e.g., a higher critical current density) than those of conventional superconducting wires.

Also, JP-A 2005-129412 discloses a method for manufacturing an MgB₂ superconducting wire comprising the steps of: charging a powder mix of a nano-size Mg powder having an average grain diameter of less than or equal to 500 nm, a B powder, and also SiC (silicon carbide) as an additive into a metallic sheath tube; subjecting the sheath tube to wiredrawing processing; and further subjecting the drawn wire to a heat treatment at temperatures ranging from 500 to 800° C. According to JP-A 2005-129412, there can be obtained an MgB₂ superconducting wire having better critical current density properties than those of conventional superconducting wires.

Moreover, JP-A 2009-134969 discloses a method for manufacturing an MgB₂ superconducting wire comprising the steps of: filling a composite sheath material composed of Cu (copper) or Cu-based alloy and Fe (iron) or Fe-based alloy with Mg and B; subjecting the sheath to wiredrawing processing; and further subjecting the drawn wire to a heat treatment, wherein the sheath is repeatedly subjected to wiredrawing processing and intermediate heat treatment at temperatures between 500 and 540° C. According to JP-A 2009-134969, there can be obtained an MgB₂ superconducting wire that has excellent critical current density properties that are equivalent to those of conventional wires and is longer than conventional wires (i.e. can be manufactured without breakage).

In addition, Tan et al. have reported a study on co-addition of C (carbon) and CaCO₃ (calcium carbonate) to a bulk MgB₂ superconductor (0 to 10 mass % addition). According to the study, an addition of 5 mass % most improved the critical current density in a magnetic field and the irreversibility field of the bulk MgB₂ superconductor. (K. S. Tan, S. K. Chen, B-H. Jun, and C-J. Kim: “Enhancement in critical current density and irreversibility field of bulk MgB₂ by C and CaCO₃ co-addition,” Supercond. Sci. Technol. 21 (2008) 105013.)

As stated above, a superconducting wire is required to maintain excellent superconducting properties even in a strong magnetic field generated by itself and to be a long length (e.g., 1 km or longer) of homogeneous wire to become practical. However, MgB₂ superconducting wire is still in a development stage, and therefore research and development efforts have been made mainly for the purpose of improving its superconducting properties (see JP-A 2004-192934, JP-A 2005-129412, and Tan et al.). As a result, there are few reports on long lengths of homogeneous MgB₂ superconducting wire.

Meanwhile, the MgB₂ superconducting wire disclosed in JP-A 2009-134969, which is one of the few reports on long lengths of wire, is not necessarily satisfactory in terms of design freedom (e.g., choice of its metallic sheath material) since the metallic material used for its metallic sheath is limited to a metal that can be annealed at temperatures from 500 to 540° C. In other words, what is required is a manufacturing method that can improve the superconducting properties and increase the length of a wire irrespective of the metallic sheath material.

### SUMMARY OF THE INVENTION

In view of the foregoing, it is an objective of the present invention to provide a method for manufacturing long lengths of MgB₂ superconducting wire having excellent superconducting properties and an MgB₂ superconducting wire manufactured thereby.

(I) According to one aspect of the present invention, there is provided a method for manufacturing a magnesium diboride superconducting wire, comprising the successive steps of: filling a metallic tube with a raw material powder; and subjecting the tube to wiredrawing processing, in which a fatty acid metal salt or a mixture of the fatty acid metal salt and a fatty acid is added to the raw material powder.

In the above aspect (I) of the invention, the following modifications and changes can be made:

(i) The fatty acid or the fatty acid constituting the fatty acid metal salt is one selected from: butyric acid, valeric acid, caproic acid, enanthic acid, caprylic acid, pelargonic acid, capric acid, lauric acid, myristic acid, pentadecylic acid, palmitic acid, palmitoleic acid, margaric acid, stearic acid, oleic acid, vaccenic acid, linoleic acid, linolenic acid, eleostearic acid, nonadecanoic acid, arachidic acid, icosatrienoic acid, arachidonic acid, behenic acid, lignoceric acid, nervonic acid, cerotic acid, montanic acid, and melissic acid.

(ii) The metal element constituting the fatty acid metal salt is a group 2 element (more specifically, magnesium (Mg), calcium (Ca), strontium (Sr), or barium (Ba)).

(iii) The amount of the fatty acid metal salt or the mixture added to the raw material powder is not less than 0.001 mass % but not more than 20 mass % with respect to the raw material powder.

(iv) Heat treatment is conducted in a non-oxidizing atmosphere in a temperature range of higher than or equal to 600° C. after the wiredrawing processing.

(v) The non-oxidizing atmosphere is an argon (Ar) atmosphere comprising less than or equal to 10 ppm each of moisture (H₂O) and oxygen (O₂) or a vacuum having a degree of vacuum greater than or equal to medium vacuum (100 Pa).

(vi) The metallic tube is composed of iron (Fe), copper (Cu), niobium (Nb), tantalum (Ta), nickel (Ni), an alloy thereof, or a combination thereof.

(II) According to another aspect of the present invention, there is provided a magnesium diboride superconducting wire manufactured by filling a metallic tube with a raw material powder containing a fatty acid metal salt as an additive and then subjecting the tube to wiredrawing processing, in which oxide particles of a metal element constituting the fatty acid metal salt are dispersed among crystal particles of magnesium diboride contained in the superconducting wire.

In the above aspect (II) of the invention, the following modifications and changes can be made:

(vii) There is provided a superconducting coil including the MgB₂ superconducting wire.

(viii) There is provided a superconducting magnet system comprising the superconducting coil.

### ADVANTAGES OF THE INVENTION

According to the present invention, it is possible to provide a method for manufacturing long lengths of MgB₂ superconducting wire having excellent superconducting properties and an MgB₂ superconducting wire manufactured thereby.

### BRIEF DESCRIPTION OF THE DRAWINGS

FIG. 1 is a schematic illustration showing a cross-sectional view of an exemplary structure of an MgB₂ superconducting wire manufactured by a method in accordance with the present invention.

FIG. 2 is a graph showing evaluation results of Example 1 and Comparative example 1 (relationships between critical current density and applied magnetic field).

FIG. 3 is a schematic illustration showing a cross-sectional view of another exemplary structure of an MgB₂ superconducting wire manufactured by a method in accordance with the present invention.

### DETAILED DESCRIPTION OF THE PREFERRED EMBODIMENTS

Preferred embodiments of the present invention will be described hereinafter with reference to examples. It should be noted that the present invention is not limited to the examples described herein, and appropriate combinations and modifications can be implemented without changing the gist of the invention.

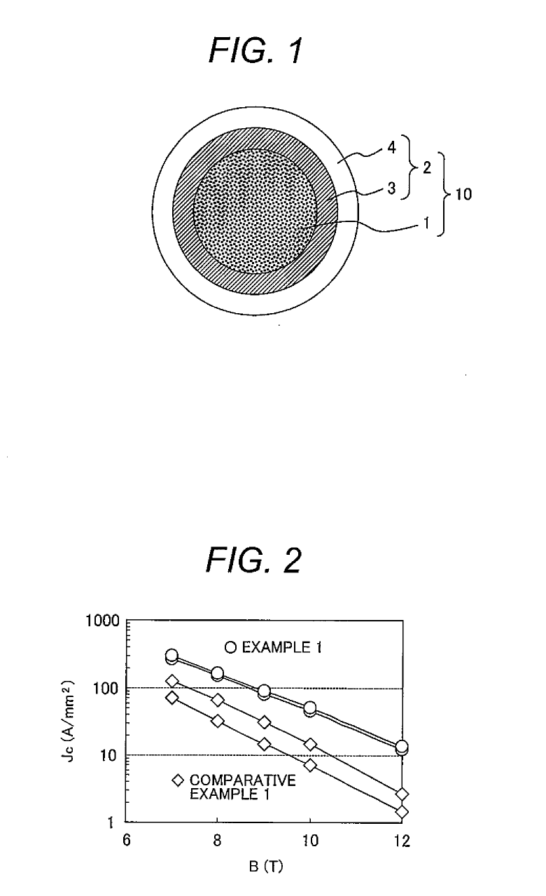

FIG. 1 is a schematic illustration showing a cross-sectional view of an exemplary structure of an MgB₂ superconducting wire manufactured by the method in accordance with the present invention. As shown in FIG. 1, the MgB₂ superconducting wire 10 is composed of a superconducting core 1 and a metallic sheath 2. In FIG. 1, a composite tube composed of a Cu layer, which is a stabilizing layer 4, and an Nb layer, which is a barrier layer 3 (hereinafter referred to as “Cu/Nb tube”) is used for the metallic sheath 2. As the stabilizing layer 4, Cu, aluminum (Al), silver (Ag), gold (Au), or an alloy thereof can be used. Also, as the barrier layer 3, Nb, Fe, Ta, Ni, or an alloy thereof can be used.

### Preparation of Example 1

An Mg powder having an average grain diameter of less than or equal to 45 μm and a purity of greater than or equal to 99%, and a B powder having an average grain diameter of less than or equal to 1 μm and a purity of greater than or equal to 95% were used as the raw material powders for the MgB₂ superconductor. First, the Mg powder and the B powder were weighed in a glove box filled with Ar gas so that the mole ratio of the Mg and the B is 1:2, which is the stoichiometry of Mg and B in MgB₂. After the two powders were put into a ball mill pot, the pot was sealed.

Herein, the amount of moisture (H₂O) and the amount of oxygen (O₂) is preferably less than or equal to 10 ppm each. When they exceed this amount, the raw material powder (especially the Mg powder) is likely to be oxidized, which results in degraded superconducting properties. Also, the mixture ratio of the Mg powder and the B powder does not have to be exactly 1:2. A preferred ratio is 1.0:1.5 to 1.0:3.0, and a particularly preferred ratio is 1.0:2.0 to 1.0:2.5.

The sealed pot was taken out of the glove box, and the raw material powder was mixed by using a planetary ball mill device at 400 rpm for 8 hours. Instead of the planetary ball mill device, devices such as a ball mill device, a V-mixer, a mortar, and the like can be used herein to mix the powder.

Next, calcium stearate was added to the mixed raw material powder in an amount of 5.0 mass % with respect to the mixed raw material powder, and the raw material powder was mixed by using a V-mixer device for one hour to obtain a raw material powder containing an additive. Herein, a preferred amount of fatty acid metal salt to be added is 0.001 to 20 mass % with respect to the raw material powder. This is because an amount of less than 0.001 mass % is too small to obtain any advantageous effect concerning workability in increasing the length of a wire and homogeneity over long lengths and the carbon doping effect concerning superconducting properties (see details below). On the other hand, an amount of greater than 20 mass % translates to a too much content of carbon, which results in degraded superconducting properties.

The raw material powder thus obtained was heat treated prior to a filling process (in an Ar atmosphere at temperatures of 450 to 650° C. for a time period of 1 to 30 hours, for example) to obtain a filler powder. Herein, it was confirmed separately that a heat treatment process prior to a filling process was optional and similar results was successfully obtained without any such heat treatment process.

A Cu/Nb tube (outer diameter of 18.0 mm, inner diameter of 11.0 mm, length of 500 mm, for example) was prepared as a metallic tube to be used as the metallic sheath. The Cu/Nb tube was filled with the filler powder prepared as mentioned above to obtain a powder-filled billet. Then the powder-filled billet was subjected to wiredrawing processing with a drawbench equipment. As a result, a long wire having a diameter of 1.2 mm and a length of 150 m was obtained without any breakage. Finally, the long wire was heat treated for sintering in an Ar atmosphere (moisture and oxygen content: less than or equal to 10 ppm each) at a temperature of 660° C. for one hour to obtain an MgB₂ superconducting wire of Example 1.

Herein, the heat treatment temperature (sintering temperature) is preferably 500 to 900° C., and more preferably 600 to 660° C. Also, other than Ar, a preferred heat treatment atmosphere is an inert gas such as nitrogen (N₂) or a vacuum having a degree of vacuum greater than or equal to medium vacuum (collectively called “non-oxidizing atmosphere”). In either case, a preferred content of moisture and oxygen is less than or equal to 10 ppm each.

### Preparation of Comparative Example 1

For purposes of comparing wiredrawing workability, the inventors fabricated an MgB₂ superconducting wire of Comparative example 1 having a diameter of 1.2 mm by using a raw material powder that does not contain calcium stearate by means of procedures similar to those of Example 1. However, during wiredrawing processing of a wire having a diameter of 1.4 mm and a wire having a diameter of 1.3 mm, two to three each of wire breakages occurred, and long lengths of wire could not be obtained stably. Based on this result, it was confirmed that use of a raw material powder containing calcium stearate (a raw material powder containing an additive) improved stability (workability) in wiredrawing processing.

(Evaluation of Superconducting Properties)

The superconducting properties of the MgB₂ superconducting wires of Example 1 and Comparative example 1 thus fabricated were evaluated. FIG. 2 is a graph showing evaluation results of Example 1 and Comparative example 1 (relationships of critical current density J_{c} of the MgB₂ superconducting wire and applied magnetic field B). Herein, the measurement samples of Example 1 (short wires having a length of about 3 cm) were cut from both ends of a long wire having a length of 150 m. Since breakage occurred during the wiredrawing process, the measurement samples of Comparative example 1 were cut from both ends of a wire having the longest length. In the measurement, a vertical magnetic filed was applied to flowing current in liquid helium (at 4.2 K).

As shown in FIG. 2, the MgB₂ superconducting wire of Example 1 exhibited excellent critical current density properties of 300 A/mm² and 280 A/mm² under 7 T magnetic field, and the variation between samples was small. On the other hand, the MgB₂ superconducting wire of Comparative example 1 had a critical current density that is as small as ⅓ to ⅕ of that of Example 1, and the variation between samples was large. Also, a non-inductive type superconducting magnet was fabricated from the remaining portion of the long wire of Example 1, and its superconducting properties were evaluated. As a result, it was confirmed that the magnet had superconducting properties that are comparable to those of a sample having a short length.

Based on the above-mentioned evaluation results of wiredrawing workability and superconducting properties, it was confirmed that the MgB₂ superconducting wire fabricated from a raw material powder containing a fatty acid metal salt as an additive in accordance with the present invention had excellent wiredrawing workability, superconducting properties, and homogeneity over long lengths compared to conventional MgB₂ superconducting wires fabricated from a raw material powder that does not contain a fatty acid metal salt as an additive.

(Discussions on Wiredrawing Workability and Homogeneity Over Long Lengths)

Fatty acid metal salts including calcium stearate used in an embodiment of the present invention produce an absorption film on a metal surface and work as what is called metallic soap. It can be considered that in the method for manufacturing an MgB₂ superconducting wire in accordance with the present invention, this absorption film formed on the surface of each particle of the raw material powder improves lubricity among raw material powder particles and between the raw material powder and the inner surface of the metallic tube, resulting in reduced frictional resistance. In other words, it is considered that the film improved the fluidity of the entire raw material powder filled in the tube and dramatically reduces the breakage rate in the wiredrawing process. Also, the improved fluidity of the raw material powder as a whole prevented consolidation and agglomeration of powder particles, thus resulting in more homogeneous distribution of the raw material powder in the metallic sheath. Based on these, it can be said that the MgB₂ superconducting material in accordance with the present invention had excellent wiredrawing workability and high homogeneity over long lengths.

(Discussions of Superconducting Properties)

It is considered that the following three items have contributed to the improvement of superconducting properties (electrical conduction): (a) carbon doping effect in the sintering process of MgB₂; (b) magnetic flux pinning effect attributable to an oxide of the metal element constituting the fatty acid metal salt; and (c) oxidation inhibitory effect by the production of an absorption film and a metal oxide. Each of the three items will be discussed hereinafter.

(a) Carbon Doping Effect in Sintering Process of MgB₂

The fatty acid metal salt used in the present invention (such as calcium stearate, melting point: 179° C.) decomposes into fatty acid and metal with elevating temperature, and eventually carbon and the dissociated metal remain on the surface of each particle of the raw material powder. Therefore, it is thought that carbon, the dissociated metal, and an oxide of the dissociated metal are present on the interfaces among raw material powder particles. In such a state, the MgB₂ superconductor is subjected to reaction sintering in the sintering process, which can be considered to produce a carbon doping effect on the finished product of MgB₂ superconductor (see JP-A 2005-129412 and Tan et al.).

(b) Magnetic Flux Pinning Effect Attributable to Oxide of Metal Element Constituting Fatty Acid Metal Salt

As stated above, it is thought that at high temperatures, carbon and metal that have been decomposed and dissociated from a fatty acid metal salt and an oxide of the dissociated metal are present at the interfaces among particles of a raw material powder containing the fatty acid metal salt. Among them, the oxide of the dissociated metal is considered to segregate on MgB₂ crystal grain boundaries when the MgB₂ superconductor is reaction-sintered, which inhibits coarsening of MgB₂ crystal grains. This leads to an increase in the number of crystal grain boundaries of the MgB₂ superconductor. In other words, magnetic flux pinning centers attributable to the oxide of the metal dissociated from the fatty acid metal salt (e.g. crystal grain boundaries of the MgB₂ superconductor and the metal oxide) have been introduced to the MgB₂ superconductor fabricated from a raw material powder containing a fatty acid metal salt as an additive in accordance with the present invention, resulting in improved superconducting properties of the MgB₂ superconducting wire.

(c) Oxidation Inhibitory Effect by Production of Absorption Film and Metal Oxide

As stated above, the fatty acid metal salt used in the present invention forms an absorption film on the surface of raw material powder particles and decomposes into carbon and metal that constitute the fatty acid metal salt at high temperatures. Herein, it can be considered that metal particles produced by this decomposition has a much smaller size than that of the raw material powder particles and are more chemically active (i.e. have a higher surface energy). Accordingly, the metal particles are thought to preferentially combine with oxygen to produce an oxide, and as a result, they serve as an oxygen getter to inhibit oxidation of the raw material powder.

### Preparation of Example 2

An Nb tube was prepared as a metallic tube to serve as a barrier layer, and the Nb tube was filled with a filler powder prepared by means of procedures similar to those of Example 1 to produce a powder-filled billet. The powder-filled billet was drawn with a drawbench equipment to a predetermined dimension, and six wires for filaments were cut from the drawn wire. A Cu tube having six holes was separately prepared as a stabilizing layer, and the six wires were inserted to the six holes to produce a multi-filamentary billet.

Then the multi-filamentary billet was drawn with a drawbench equipment. As a result, a wire having a diameter of 1.2 mm and a length of 200 m was obtained without any breakage, which demonstrated that the billet had excellent wiredrawing workability. Finally, the long wire was heat treated for sintering in a vacuum of 1 Pa at a temperature of 660° C. for one hour to obtain an MgB₂ superconducting wire of Example 2.

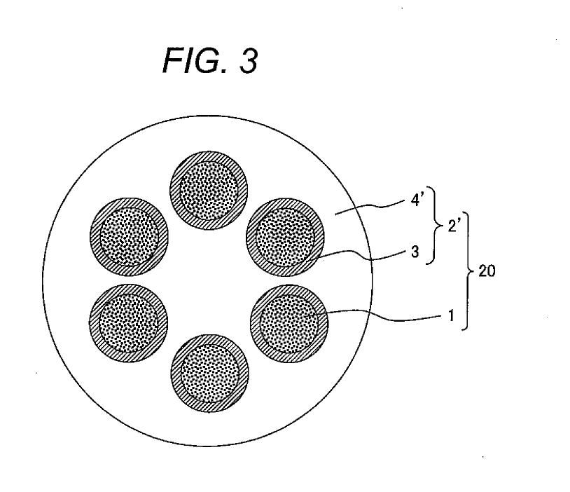

FIG. 3 is a schematic illustration showing a cross-sectional view of another exemplary structure of an MgB₂ superconducting wire manufactured by the method in accordance with the present invention. As shown in FIG. 3, the MgB₂ superconducting wire 20 is composed of a superconducting core 1 and a metallic sheath 2′. In FIG. 3, the metallic sheath 2′ is composed of a Cu layer, which serves as a stabilizing layer 4′, and an Nb layer, which serves as a barrier layer 3. The superconducting properties of the MgB₂ superconducting wire of Example 2 thus fabricated were evaluated, and it was confirmed that the MgB₂ superconducting wire of Example 2 had excellent superconducting properties and homogeneity over long lengths as was the case with Example 1.

While the present invention has been described with reference to Examples 1 and 2, in which the MgB₂ superconductors were produced in a metallic sheath (what is called “in-situ method”), it is not limited thereto, and it has been separately confirmed that the same effects can be obtained by a method wherein a metallic tube is filled with an MgB₂ powder synthesized beforehand as a raw material powder (what is called “ex-situ method”).

Also, while the present invention has been described with exemplary embodiments in which calcium stearate is used as a typical fatty acid metal salt, it is not limited thereto. For example, butyric acid, valeric acid, caproic acid, enanthic acid, caprylic acid, pelargonic acid, capric acid, lauric acid, myristic acid, pentadecylic acid, palmitic acid, palmitoleic acid, margaric acid, oleic acid, vaccenic acid, linoleic acid, linolenic acid, eleostearic acid, nonadecanoic acid, arachidic acid, icosatrienoic acid, arachidonic acid, behenic acid, lignoceric acid, nervonic acid, cerotic acid, montanic acid, and melissic acid can be used as a fatty acid instead of stearic acid to produce the same effects. Meanwhile, Mg, Sr, and Ba can be used instead of Ca as a metal element to produce the same effects.

Moreover, there is no particular limitation on applications of the MgB₂ superconducting wire in accordance with the present invention, and the wire is applicable to current leads, power transmission cables, large magnets, nuclear magnetic resonance analysis (NMR) devices, magnetic resonance imaging (MRI) apparatuses for medical use, superconducting magnetic energy storage (SMES) devices, magnetic separators, magnetic single crystal pulling-up devices, refrigerator cooling superconducting magnet devices, flywheel energy storage devices, superconducting power generators, nuclear fusion reactor magnets, and the like.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A method for manufacturing a magnesium diboride superconducting wire, comprising the successive steps of:
filling a metallic tube with a raw material powder; and
subjecting the tube to wiredrawing processing,
wherein a fatty acid metal salt or a mixture of the fatty acid metal salt and a fatty acid is added to the raw material powder.

2. The method for manufacturing a magnesium diboride superconducting wire according to claim 1, wherein the fatty acid or the fatty acid constituting the fatty acid metal salt is one selected from: butyric acid, valeric acid, caproic acid, enanthic acid, caprylic acid, pelargonic acid, capric acid, lauric acid, myristic acid, pentadecylic acid, palmitic acid, palmitoleic acid, margaric acid, stearic acid, oleic acid, vaccenic acid, linoleic acid, linolenic acid, eleostearic acid, nonadecanoic acid, arachidic acid, icosatrienoic acid, arachidonic acid, behenic acid, lignoceric acid, nervonic acid, cerotic acid, montanic acid, and melissic acid.

3. The method for manufacturing a magnesium diboride superconducting wire according to claim 1, wherein a metal element constituting the fatty acid metal salt is a group 2 element.

4. The method for manufacturing a magnesium diboride superconducting wire according to claim 1, wherein the amount of the fatty acid metal salt or the mixture added to the raw material powder is not less than 0.001 mass % but not more than 20 mass % with respect to the raw material powder.

5. The method for manufacturing a magnesium diboride superconducting wire according to claim 1, wherein heat treatment is conducted in a non-oxidizing atmosphere in a temperature range of higher than or equal to 600° C. after the wiredrawing processing.

6. The method for manufacturing a magnesium diboride superconducting wire according to claim 5, wherein the non-oxidizing atmosphere is an argon atmosphere comprising less than or equal to 10 ppm each of moisture and oxygen or a vacuum having a degree of vacuum greater than or equal to medium vacuum.

7. The method for manufacturing a magnesium diboride superconducting wire according to claim 1, wherein the metallic tube is composed of iron, copper, niobium, tantalum, nickel, an alloy thereof, or a combination thereof.

8. A magnesium diboride superconducting wire manufactured by the method for manufacturing a magnesium diboride superconducting wire according to claim 1.

9. A magnesium diboride superconducting wire manufactured by filling a metallic tube with a raw material powder containing a fatty acid metal salt as an additive and then subjecting the tube to wiredrawing processing, wherein oxide particles of a metal element constituting the fatty acid metal salt are dispersed among crystal particles of magnesium diboride contained in the superconducting wire.

10. The magnesium diboride superconducting wire according to claim 9, wherein the metallic tube is composed of iron, copper, niobium, tantalum, nickel, an alloy thereof, or a combination thereof.

11. A superconducting coil of the magnesium diboride superconducting wire according to claim 9.

12. A superconducting magnet system comprising the superconducting coil according to claim 11.
